(19) United States
(12) Patent Application Publication
(10) Pub. No.: US 2008/0250587 A1
(43) Pub. Date: Oct. 16, 2008

(54) Internal external pipe deburring hanging sand cloth dispenser

(76) Inventor: David Allen Bryant, Longmont, CO (US)

Correspondence Address: David Allen Bryant Jr., 1768 Antero dr., Longmont, CO, 80501, US

(21) Appl. No.: 11/787,417

(22) Filed: Apr. 16, 2007

(51) Int. Cl. B08B 9/02

(52) U.S. Cl. 15/104.03

(57) ABSTRACT

One embodiment is a lightweight, hand held, hanging, plastic sand cloth dispenser with a pipe reamer and a file. This design is for the deburring of tubing or pipe and the cleaning of said tubing or pipe, while the hanger enables the dispenser to be kept within reach.

### CROSS-REFERENCE TO RELATED APPLICATIONS

none

### FEDERALLY SPONSORED RESEARCH

not applicable

### SEQUENCE LISTING OR PROGRAM

not applicable

### BACKGROUND

1. Field of Invention

This invention relates to the dispensing of sand cloth for the purposes of cleaning tubing or pipe. It also relates to the deburring and reaming of copper tubing for the preparation of soldering or brazing.

2. Prior Art

Plumbers and pipe fitters have struggled for years with carrying a lot of extra weight in their tool bags and with having to constantly stoop down or climb down their ladder to retrieve the sand cloth that they dropped while cleaning copper tubing.

Sand cloth generally comes in a small square box. The user must tear off a length of it for use. There are several ways of storing the remainder. Put it back in the box, throw it in the toolbox or tool bucket, or drop it on the floor. These do not prevent the sand cloth from getting damaged or make it readily available if more is needed especially if one is up a ladder.

Several patents have been cited which relate to sand cloth dispensing, the most pertinent being as follows:

U.S. Pat. No. 2,189,980 issued to Forsblade, entitled “Holder for Sandpaper and the like”, relates to an apparatus having a pair of spaced apart upper and lower sections that are attached by hinge, to accommodate each section accommodating sandpaper. There is inserted a wood block intermediate the free ends of the section so that as pressure is applied to the block in the free ends, the sandpaper is engaged in position against the block and therefore sanding is accomplished. U.S. Pat. No. 5,295,278 (1994) U.S. Pat. No. 5,307,534 (1994) U.S. Pat. No. 4,790,121 (1988) . . . all are about the actual cleaning of the pipe.

### SUMMARY

In accordance with one embodiment, a compact storage dispenser for sand cloth, a file imbedded in the bottom and a pipe reamer at the rear.

### DRAWINGS—FIGURES

FIG. 1 shows a perspective view of the left side of the dispenser, showing the hook, thumb indent and release button for the reamer blade

FIG. 2 shows a perspective view of the right side of the dispenser, showing the tab release for the door of the sand cloth chamber. It also shows the position of the reamer blade housing.

FIG. 3 shows a perspective view of the top of the dispenser, showing how the sand cloth is secured to the outside of the dispenser.

FIG. 4 shows a perspective view of the bottom of the dispenser, showing the files location.

FIG. 5 shows a perspective view of the rear of the dispenser, showing how the dispenser is an oval shape.

FIG. 6 shows a perspective view of the front of the dispenser, showing the dispensing slot and the position of the reamer.

FIG. 7 shows an internal perspective view of the dispenser, showing the storage compartment of extra reamer blades and the roller pins that the sand cloth lace around for ease of dispensing the sand cloth.

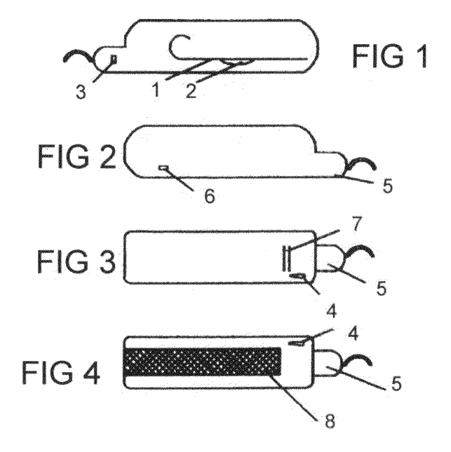

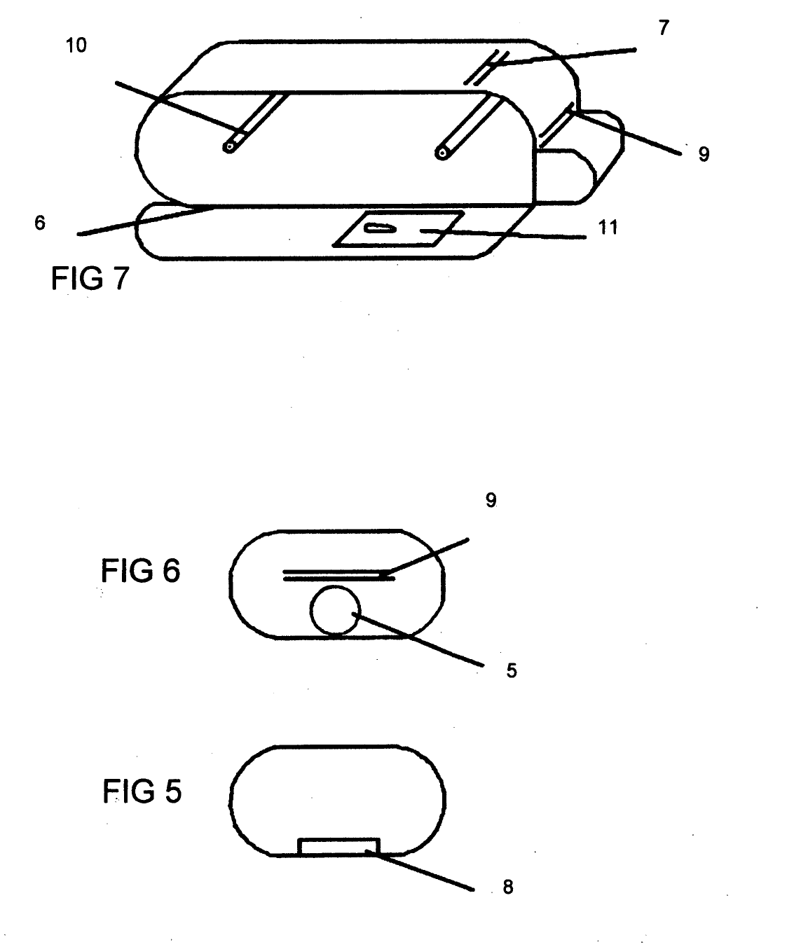

### DRAWINGS—REFERENCE NUMERALS

| | | | |
|---|---|---|---|
| 1 | Hanger | 2 | Thumb slot |
| 3 | Push button | 4 | Tab Release |
| 5 | Reamer | 6 | Hinge |
| 7 | Retaining Slot | 8 | File |
| 9 | Dispensing Slot | 10 | Roller Pins |
| 11 | Storage Compartment | | |

### DETAILED DESCRIPTION—PREFERRED EMBODIMENT

One embodiment of the dispenser as illustrated in FIGS. 1 thru 7. The dispenser is made of a lightweight durable plastic. Number 1 in FIG. 1 is the hanger. The hanger is form fitted and attached to the side of the dispenser. To use the hanger one pulls it away from the body of the dispenser by placing thumb and forefinger in the thumb slot 2 and pull. The hanger allows for the dispenser to hang from the work area, tool belt or pocket. The push button 3 in FIG. 1 allows the reamer blade to be removed. The push button is slotted and holds the reamer blade firmly in the dispenser, allowing the blade to swivel but remain in the dispenser.

The release tabs 4 in FIG. 2 when squeezed together will release the locking clip and allow the right side of the dispenser to open. The right side will not pull away from the dispenser but pull outward and be attached by a hinge 6 preventing loss or damage to the right side of the dispenser. Location of the reamer 5 is centered at the bottom portion of the front of the dispenser allowing the sand cloth to be dispensed through 9 the dispensing slot. The retaining slot 7 will secure the sand cloth to the dispenser.

The file 8 can be used to remove any burrs on the outside of tubing or pipe. The right side, FIG. 2 when opened will have a storage compartment 11 to store extra reamer blades. Sand cloth can be inserted into the dispenser over the roller pins 10. The roller pins 10 will protrude out of the left inside body. There will be sleeves over the pins that when sand cloth is wound around the pins and feed through the dispensing slot 9, the sand cloth will dispense smoothly.

I claim:

1. In a sand cloth dispenser of this type, the materials it is made up of may be of a lightweight plastic. It will hold and dispense up to 25 ft. of single sided or a mesh style sand cloth. The sand cloth will be fed through the dispensing slot just above the pipe reamer. The sand cloth will loop out and fold back to the top of the dispenser where it will be secured by the retaining slot. There is a compartment in the access panel to store extra reamer blades. The reamer will protrude from the front of the dispenser. The reamer blade removes the burr from the inside of tubing or pipe. The file is embedded in the bottom of the dispenser. The file removes the burr from the outside of tubing or pipe. The hook may be used to hang the dispenser.
